(19) United States
(12) Patent Application Publication
(10) Pub. No.: US 2011/0173068 A1
(43) Pub. Date: Jul. 14, 2011

(54) UNIFIED DATA BURST INTERNET ADVERTISING AND EM ALERT METHODS

(75) Inventor: David Joseph O'Hanlon, Miller Place, NY (US)

(73) Assignee: David Joseph O'Hanlon, Miller Place, NY (US)

(21) Appl. No.: 12/685,685

(22) Filed: Jan. 12, 2010

(51) Int. Cl. G06Q 30/00; G06F 15/18; G06F 9/44; G06F 3/048

(52) U.S. Cl. 705/14.52; 705/14.66; 705/14.49; 706/12; 717/173; 715/810

(57) ABSTRACT

There is a need for an internet advertisement “Emergency Management, Terrorist, Amber, and Imminent Weather Danger Alert System”. An internet alert system that bypasses business advertisements and uses data burst impressions immediately in the place of at least one advertisement per page and automatic email to every authority network member, having efficient and successful configurations resourceful to Local, State, and Federal Government authorities through at least one computer system internet advertising database configuration and user profile interface configuration and incorporated useful at least one method herein on authority computers, mobile phones, mobile workstations, including work stations that include at least one server and personal digital assistants through touch-screens, voice commands, or keyboards, each having hard, high-density, optical or laser drives with at least on computer processing unit(CPU) and sufficient random access memory(RAM) including a binary operating system, at least one high speed satellite, cellular, Internet Protocol telephony, or land-line, such as cable, at least one modem or transmitter/receiver internet capability, and at least one said unit demand, including high-speed local company networks, upon at least one internet advertising company controls.

### FIELD OF THE PRESENT INVENTION

The present invention relates to the unified field of business methods of computer internet advertising, data burst internet advertising impression technology, and terrorism, amber, and imminent weather alert configurations through database bypass of business internet advertisements and accelerated impressions.

### BACKGROUND OF THE INVENTION

First, there is a need for an internet advertisement “Emergency Management, Terrorist, Amber, and Imminent Weather Danger Alert System”. An internet alert system that bypasses business advertisements and uses data burst impressions immediately in the place of at least one advertisement per page and automatic email to every authority network member, having efficient and successful configurations resourceful to Local, State, and Federal Government authorities through at least one computer system internet advertising database configuration and user profile interface configuration and incorporated useful at least one method herein on authority computers, mobile phones, mobile workstations, including work stations that include at least one server and personal digital assistants through touch-screens, voice commands, or keyboards, each having hard, high-density, optical or laser drives with at least on computer processing unit(CPU) and sufficient random access memory(RAM) including a binary operating system, at least one high speed satellite, cellular, Internet Protocol telephony, or land-line, such as cable, at least one modem or transmitter/receiver internet capability, and at least one said unit demand, including high-speed local company networks, upon at least one internet advertising company controls. This opens a new horizon for use in aircraft to ground emergency notification. It is especially useful in large storm data collection flying that affects states and notification to potential on ground tornado victims in local areas as well. Alerts can be designed around text, image and video formats that are readily acceptable to display in geographical areas within said user profile interface wherein commands close running ad script and use embedding at least one open dialog chat box or real-time streaming video open ad formats.

Second, computer system internet advertising, but not limited to, at least one image, video, text, animation, and even computer to television advertising, hereinafter internet advertisements, all lack a basic premise. That premise is the ability for one to tell if they would prefer more information or even buy what they see. Said internet advertisements may be screened for policy and family content but a marketing professional is too inadequate to know that a plurality of said internet advertisements could be useful. Therefore, the use of ramping up or accelerating at least one computer search, content, and specific computer to television said internet advertisement's impressions in at least one data burst above at least one other advertisements hierarchy is important to gauge at least the likelihood said internet advertisements real world function for information purposes or purchasing or appeal. It is an important transformation of data to create said data burst for said internet advertisements, wherein said internet advertisements stoppage, having an unmet need to the consumer to quickly reach potential again as proof of previous performance, or for participants willing to engage in tests, such as but not limited to, said tests valued for certain ranges of click through ratio percentages, geographical demand increases, or conversion ratio, as competitive advantage opportunities. Said data burst method also extends to consumers personally certifying a likelihood probability said internet advertisements performance use will be of value through opting in manually. Or a system may use said data burst for new said internet advertisements making transformation of data an extremely keen key in simplicity in the present invention.

Lastly, in the business method database model for computers, laptops, mobile phones, workstations, and personal digital assistants, and to make the said data burst method alerts more apparent, there is a need for a data set containing at least one window at least one data input or opt in field to calculate likelihood probability of said internet advertisements performance in database systems that use a data burst screening yield throughput method. As explained previously, the data burst method is a stand alone transformation of computer system data operated in unison with new said internet advertisements. However, a said data burst screening tool based wherein said calculated likelihood probability data set display at least one update of a score from one to one hundred, the normal mathematical equivalent of zero to one, then said calculated likelihood probability data set, is additional matter to computer said internet advertisements, wherein unifying data sets creates a unified database computer system profile interface, hereinafter unified database and unified database user profile. This is powerful interoperability in data set management having at least one workflow wherein said calculated likelihood probability data set can display unison access said consumer said score through parent said unified database designated field display.

### OBJECTS OF THE INVENTION

It is therefore an object of the present invention to be useful to various person types, such as, governmental work authorities, business owners, and business entities, having easy use of the internet environment access tools and user access to a unified data computer advertising system iteration calculations that result from tests and output.

Another object of the present invention is to provide an efficient emergency management alert system or method therefore.

Another object of the present invention is to provide an economically feasible manufacturing cost.

A further object of the present invention is to provide a useful computer system user profile unified database probability system for someone to do advertising on the internet, quickly, effectively, and with higher proficiency.

It is also an object of the present invention to provide a unique database to make calculations based upon user defined advertisement probability data structure trees in a result driven environment.

A still further object of the present invention is to provide a data burst of internet advertising impressions, for users to control a through-put of an advertisement to consumers and ramp up the speed to utilize new or previous ads that may be laying dormant due to budget, inadvertent stoppage, or other reason for an otherwise highly likely advertisement positive result.

A yet further object of the present invention is to provide a practical use of drawings and claims to exemplify and address the needs of all users.

### SUMMARY OF THE INVENTION

In keeping with the objects of the invention, an internet advertisement “Emergency Management, Terrorist, Amber, and Imminent Weather Danger Alert System” that bypasses business advertisements and uses data burst impressions immediately in the place of at least one advertisement per page and automatic email to every authority network member, having efficient and successful configurations resourceful to Local, State, and Federal Government authorities, such as but not limited to, the Federal Emergency Management Agency, through at least one internet advertising computer system database configuration and user profile interface configuration and incorporated useful at least one method herein on authority computers, mobile phones, mobile workstations, including work stations that include at least one server and personal digital assistants through touch-screens, voice commands, or keyboards, each having hard, high-density, optical or laser drives with at least on computer processing unit(CPU) and sufficient random access memory(RAM), a binary operating system and at least one high speed satellite, cellular, Internet Protocol telephony, or land-line, such as cable, at least one modem or transmitter/receiver internet capability, and at least one said unit demand, including high-speed local company networks, upon at least one internet advertising company controls. This opens a new horizon for use in aircraft to ground emergency notification. Ideally, so many computer users are on computers at the time of imminent danger and need notification. It is especially useful in aircraft flying through large storm data collecting data that affects states and notification to potential on ground tornado victims in local areas as well. Alerts can be designed around text, image and video formats that are readily acceptable to display in geographical areas within user profile interface configurations or wherein commands close running ad script and use embedding open dialog chat boxes or real-time streaming video open ad formats.

The computer system said internet advertising, using preferable data wherein said internet advertisements use said data burst within at least one computer search, content, and specific computer to television said internet advertisement's webpage placement in at least one data burst above at least one other advertisements hierarchy containing functional transformation wherein said internet advertisements stoppage, having an unmet need to the consumer to quickly reach potential again as proof of previous performance, or for participants willing to engage in tests, such as but not limited to, said tests valued for certain ranges of click through ratio percentages, geographical demand increases, or conversion ratio, said internet advertisements performance useful in iteration sequence computations and results allowing said consumer opting in, such as but not limited to, manually choosing their internet advertisement in competitive advantage opportunities or more simply transformation said data burst an extremely keen key.

The business method model for computers, laptops, mobile phones, workstations, and personal digital assistants, wherein need for a data set containing at least one window at least one data input or opt in field to calculate likelihood probability of said internet advertisements performance in database systems that use a data burst screening yield throughput method. Said data burst screening yield throughput tool created wherein said calculated likelihood probability data set display at least one update of a score from one to one hundred, the normal mathematical equivalent of zero to one, then said calculated likelihood probability data set, is additional matter to computer said internet advertisements, wherein unifying data sets creates a unified database computer system and user profile interface, hereinafter unified database or said unified user database profile having consumer orientation said unified database, wherein further said screening yield throughput said data burst said calculated likelihood probability data set said unified database output having, but no limited to, new requirements, such as, updated click through ratio tests, economic standard tests, limitations due to overall said score ordinates said data burst screening yield for throughput for successfulness of all running newly at least some creation said internet advertisements within said unified database said unified database user profile unison.

Said powerful interoperability data set management having at least one workflow wherein said calculated likelihood probability data set can display unison access said consumer said score through said unified database user profile unison said unified database designated field display.

In keeping with these objects and others which may become apparent, the present invention includes business implemented methods to assist authorities, computer system owner users, and commercial enterprises in advertising or sending alerts on the internet by creating said calculated probability likelihood data sets said scores directly and delivering a data burst of impressions to those interested in applying their total probability score to practical use in the market place against practical probability test scores of “customer call to actions” thus creating a revolving door of higher calculated scores and better impressions at a desired monetary level. For example, a probability test for customers would be an estimate of 0.5% click through ratio on a burst of ads and would be adequate to ramp up the impressions and keep them running as long as they satisfactorily perform. The ad could be slowed in comparison to other ads or accepted or rejected as new information predicates such.

The best example of computer advertising systems using a data burst method of impressions is for, but not limited to, the use of at least one image, video, text, animation, and even computer to television advertising. The premise for this is the ability for one to tell if they would prefer more information or even buy what they see. They may be screened for policy and family content but an internet advertising delivery company marketing professional is inadequate to know which out of a plurality of said advertisements could be useful. Therefore, the use of ramping up or accelerating at least one computer search, content, or other such computer system internet webpage advertisement impressions onto newly created at least one open impression having a fitted pixel ratio size for a webpage in a browser on the internet in an accelerated burst of data beyond at least one other advertisements hierarchy is important to gauge the likelihood an advertisement is going to work for information purposes or purchasing. It is an important transformation of data to create an acceleration or data burst for new internet ads, said ads that have not been running a while and have to reach potential again as proof of previous performance, or for participants willing to engage in tests, such as but not limited to, tests against click through ratio percentages, geographical demand increases, or conversion rates. This may even be done via, but not limited to, an html code linking a check box to a database for personally certifying an ad is good to an individual.

Significantly, in the business method model for computers, laptops, mobile phones, workstations, and personal digital assistants, and to make the method of data burst alerts more apparent, there is a need for a new probability data structure tree in database systems that use a data burst screening method. As explained previously, the data burst method is a stand alone transformation of computer system data operated in unison with new advertisements, re-engaging advertisements, and initiating by choice a new advertisement, especially, but not limited to, image, video, text, and also computer to television advertising, as available. It is such a useful transformation that one only has to say it changes data rate for exposure of ads. However, if a new data burst screening tool and computer system probability data structure tree, are used it could add to computer advertising systems as well as a computer unified database system interface, for powerful interoperability.

The probability data structure tree in basic is formed on a probability calculation of at least one element creating the hierarchy chain and if need be sub-elements defining each parameter in a probable relationship to be effective in calculating said at least one element by a score that increases an internet advertisements likely inherency or hierarchy to call a customer to action and through screening standards can therefore receive a data score for eligibility for a burst of impressions to customers. The probability data structure tree is created on a method of calculations in a unified database system located on a workstation server of an internet advertisement company. The call to action may be a parameter, such as but not limited to, clicking on an ad or an expected conversion percentage. An example of an element is a keyword. A keyword can form the hierarchy of the chain and so could geography, but is not limited to, as an example. The hierarchy keyword can be at least one word to perform better than another advertisement. This is not the probability that it will perform the call to action. This is the probability against statistical data already engaged in a database. The fundamental values for the inception of the score for the probability data structure tree is formed by, but not limited to, statistical data gathered from market information companies or economic journals or books with sufficient data on statistics for, but not limited to, internet advertisement merchandising and services. For example, the probability in mathematics of the first keyword of the first hierarchy is equal to one. In this case, the score is so high it would automatically be executed upon command to a rapid data burst of advertisement impressions to allocate a customer score by meeting exceeding the computer system unified database screening standard. The probability data structure tree is only used as a term to describe the collection of data from at least one input filed of a data set. As seen in the drawings it is at least one data up to a set created by input of information in data fields. Data fields can also be extrapolated up or down based on the calculation for a field. But is an interpolated set of input data in a data set that is transformed through probability and statistics against scenarios, to create the data burst screening tool. The formation of the data burst screening tool method allows for circulation and input from real world sources, namely, the consumer.

However, the keyword will never equal one because of statistical measures in place in the database screen. Heretofore, we will call the score from zero to one—one to one-hundred. Most computer advertising consumers count chances or probabilities in terms of percentages and usually from one to one-hundred percent. The database is the first unified database system located on the hard, high-density, laser or optical drive of a computer workstation server at a commercial advertising company that offers ads to consumers and businesses. The unified database system is designed to run test measures for probabilities for statistical variances. And when statistical measures add to the combined probability theorems for output they yield best-case scenarios. But the implementation of scenarios create a screening system that is constantly updated with revolving said data burst tests on the automatic or consumer manual level when someone submits an ad and on the increased computational levels explained herein. Where there is a need for a method of using a computer system said unified database said internet advertising system or data burst method on computer workstations in local and national level emergencies, the present invention is an efficient alert system, that necessitates in these cases to use high level system security at least (SSL) secure-socket layer systems. A good example of an authority and security is the Federal Emergency Management Agency. And for all parameters in the said unified database system or use of tools, such as, but not limited to, said data burst methods to be the equivalent to an absolute mathematical parameter of probability of one. All other cases must be discarded as Probability (n=1)=0. This can easily be written as a friendly command method conjunctive, such as, Probability=“Authority” AND “ADS”=0, where actual commands permit. Statistics are commonly sold on the open market from information gathering companies. The parameter input calculations begin with gathered statistics assigning for each parameter, such as but not limited to, a keyword or conversion, a probable likelihood a customers call to action will take place and the actual results in said data burst methods and re-iteration of the calculation in the database. The call to action may be a click through rate or conversion percentage expected. The said data burst screening tool method is used to assess said internet advertisements for data bursts of advertising impressions to the consumer. The consumers receive the data as, but not limited to, webpage or computer to TV ads.

Internet computer consumer internet said unified database user profiles for internet advertisements over the internet can be accelerated and with the precision of the said data burst screening tool method and said unified database said internet advertisement system because of the need for computer database transformation of said calculated probability likelihood data sets, said calculated probability likelihood data sets transformation score available to the consumer as creating at least one advertisement, and the additional parameters therefore, said at least one parameter change in at least one field of a data set having an input of at least one, during at least some advertising creation or thereafter, wherein said internet computer consumer said unified database user profiles having access to the plurality of advertisements used in commercial servers in real-time, said commercial servers containing continuous updated information relating to said internet advertisements, having at least one formation of a previously transformed probability from within a unified database system, from controls of at least one other unified database user profile, assisting the consumer or business advertiser in keeping unison with the computer system said unified database user profile said calculate probability likelihood data set said transformation said score, while also using said data burst of impressions for likely well performing ads to be tested by consumer actions verse economic proficient said tests, such as but not limited to, click-through rate or conversion ratio percentages created by said computer consumer actions and recalculated and scored by the system to either be available to the consumer through said unified database user profile or at least available to the commercial advertising facility workstation.

Significant applicable visible tool said unified user database profile interfaces to gauge and score each said calculated probability likelihood data set in unison with at least one entry, such as but not limited to, keywords, geography, conversions, and relative inclining and decreasing a percentage of this quantifiable information in these input field areas and others as well, while internet consumer profiles are in use both on personal computers, mobile computers, and personal digital assistants, including mobile phones, all accessing a database through land-lines, cellular technology, satellites and the like. Additionally, said calculated probability likelihood data sets begin said unified database system. When you add said internet advertising said unified user database profile interface that is accessed on a hard-drive of a computer, a personal or business computer, mobile computer, or personal digital assistant, it is allocated to operation on a hard-disk, high-density, optical or laser drive by at least one (CPU) and by at least some random access memory (RAM), through circuitry in at least one computer circuit connection in unison with a binary operating system, having at least one display, said internet advertising computer said user unified database profile interface uses in current formation and transformation said calculated probability likelihood data and is efficient in at least one computer system said unified database configuration. Said unified database said unified user database profile interface, data burst method, data burst screening tool is accessed as described by said unified database user profile interface is in data transmission relation via at least one modem or effective transmitter/receiver, to a commercial workstation server or multiple servers, having hard-disk, high-density, optical or laser drives, at least one (CPU) with motherboard circuitry access to RAM for additional proficiency, a binary operating system, with land-line, IP Telephony, Cable, and satellite access from a said user profile interface, as described.

An authority may access the computer system said unified database said unified database user profile interface or use said data burst methods bypass through accessible configuration computer user profile interface advertising database systems, but is not limited to, said unified database said unified database user profile interfaces, and designed for access on their strategically located previously described set of opportunity computer system configurations and set in position to create an alert system by having been provided to the best probability score or other system bypass method said computer system unified database said unified database user profile interface and said scoring but can also access their geographical, town, county, state, or nation in an emergency situation and immediately implement a set of pre-determined advertisements having each being a pre-determined height and a pre-determined width, usually measured in pixels for rapid use on at least one page containing at least one advertisement being not limited to at least text, of any required size, wherein text ads may request a browser refresh for additional information as updated. Alerts can be designed, but not limited to, text, image and video formats that are readily acceptable to display in geographical areas within said user profile interface or complete user profile interface wherein commands, such as but not limited to, fit at least part of the area of space or fit within the area automatically and close running said internet advertisement script and use embedding at least one open dialog chat box or real-time streaming video open ad formats.

The computer system unified system database system can be created through various software, containing data mining, probability, and network flow. The descriptions herein are exemplary for such unity. And data burst methods are both replete with information gathering as well as calculating as databases are intended to be. For example, use of common advertising systems yield best case scenarios in calculating key-words and spelling out where and when ads are displayed on the internet. However, they are not limited to only key-words going well beyond as to include timing and geography and necessitate full participant disclosure to achieve the highest excellence of operating standards for users.

In the present invention, the business implemented methods, has to be focused on only some of the terms, where, however, the usage of, “such as,” and, “but not limited to,” are used to only scratch the surface of the expert design, and are further again replete as mentioned previously, having this broad spectrum.

In a computer workflow environment having at least one commercial internet advertisement workstation computer via at least one network adapter thereto connectivity at least one internet advertising user workstation computer having at least one user using at least one internet advertising profile accessing at least one open transmission and reception communication via at least one network adapter a method for at least one internet advertising database computer system interactive computational flowing network software comprising: said at least one internet advertising user accessing said internet advertising interactive computation database profile at least one data set creating at least one internet advertisement at least one datum assigned at least one record; said datum said record at least one partially created advertisement; at least one formed binary type software computational data file created containing said record transfer said commercial advertising workstation; commercial internet advertising computer system workstation executes said database computer system interactive computation flowing database software created having at least one access at least one probability algorithm source code; accessing at least one market system statistic control; wherein at least one computation creating at least one probability score said formed binary type software computational data file and output via network said internet advertising user profile said data set said probability score thereon;

In a computer workflow environment having at least one commercial internet advertisement workstation computer via at least one network adapter thereto connectivity at least one internet advertising user workstation computer having at least one user using at least one internet advertising profile accessing at least one open transmission and reception communication via at least one network adapter a method for at least one internet advertising database computer system comprising: said user using at least one database object or at least one selection output using at least one window through at least one internet advertising data set said internet advertising user profile at least one impression acceleration advertisement at least one binary data set type file information transmits said commercial internet advertising workstation transmission; said internet advertising database computer system receiving transforms said binary data type file information said impression acceleration advertisement via increasing hierarchy said internet advertising database computer system software configured internet advertisement scoring method therein at least one drive; said internet advertising database computer system transmits at least one transformed said binary data set type file information said impression accelerated advertisement said transmitting at least one network advertiser; at least one internet consumer computer system receives via at least one network adapter at least one webpage said transformed said impression acceleration advertisement said transformed said binary data set type file information embedded said advertisement impression; said internet consumer computer user takes at least one resulting action; said resulting action said impression acceleration advertisement said transformed further said binary data set type file information transmitted fully or updating at least one parent binary set type file information data set located said internet advertising database computer system; wherein said internet advertising database computer system score system and adjusts said score;

In a computer workflow environment having at least one commercial internet advertisement workstation computer via at least one network adapter thereto connectivity at least one internet advertising user workstation computer having at least one user using at least one internet advertising profile accessing at least one open transmission and reception communication via at least one network adapter a method for at least one internet advertising database computer system: at least one internet impression acceleration advertisement at least one binary data type file information data set tested on score based actions; at least one database software having at least one incorporated probability algorithm software utilizing probability sampling or data mining, such as but not limited to, resulting transformation said binary data type file information set tested on score resulting score at least one variable association located said binary data type file information data set tested on score; transforming said binary data type file information data set tested on score said variable having independent score; wherein screening tool is produced improving at least one additional iteration utilizing said variable wherein matching at least one score identifies previous score assisting new, such as but not limited to, at least one common internet advertisement or said internet impression accelerated advertisement data probability score increased efficiency;

In a computer workflow environment having at least one commercial internet advertisement workstation computer via at least one network adapter thereto connectivity at least one internet authority user workstation computer having at least one user using at least one internet alert advisement profile accessing at least one open transmission and reception communication via at least one network adapter an alert method said internet alert advisement database computer system: said authority using at least one database object or at least one selection output using at least one window through at least one internet advisement data set said internet alert advisement authority profile at least one datum at least one record at least one internet alert advisement at least one binary data set type file information transmits said commercial internet advertising workstation transmission alert; said commercial internet advertising workstation database computer system receiving transforms said binary data type file information at least one impression necessary said commercial internet advertising workstation said at least one internet advertisement database computer system software configured at least one internet advertisement scoring method at least one top hierarchy said impression said internet alert advisement therein at least one drive; said commercial internet advertising workstation database computer system transmits at least one transformed said binary data set type file information said impression said internet alert advisement said transmitting at least one network advertiser; at least one internet consumer computer system receives via at least one network adapter at least one webpage said transformed said impression said internet alert advertisement; wherein said consumer computer system user is informed via said internet alert advisement;

A method of creating at least one computer usage probability theory algorithm wherein spectral dispersion point data having finite set (S) wherein increased said computer usage said spectral dispersion point data records approach said (S) upper limit wherein theory said computer usage probability theory algorithm continuously calculates varied said (S) said spectral dispersion point data wherein at least one developed Probability Density Algorithm is created at least at one point in time;

The method wherein efficient and successful configurations are located on computers, mobile phones, mobile workstations, including work stations that include at least one server, at least one remote authority radio or emergency operating advisement alert device, at least one personal digital assistant, having available at least one touch-screen, at least one voice command, at least one keyboard, each having at least one hard, high-density, optical, chip set, or laser drives with at least one computer processing unit(CPU) and sufficient at least one random access memory(RAM) including at least one binary operating system, at least one high speed satellite, cellular, Internet Protocol telephony, or land-line, such as cable, at least one network modem or transmitter/receiver adapter internet capability, at least one local network and at least one said at least one aforementioned at least one system located said commercial internet advertising company;

The method wherein for at least one internet advertising database computer system interactive computational flowing network software wherein user and commercial computer components update on the fly;

The method wherein said datum said record results said different than advertisement;

The method wherein said advertising datum said internet user advertising profile said commercial advertising workstation database configuration wherein increasing and decreasing said datum, including but not limited to changing the dependency on other fields;

The method wherein said internet advertising said data set said user profile uses opt in or opt out auto efficiency wherein objects, such as but not limited to option menus, toolbars, or lists offering selected tests, costs, probability and challenges;

The method wherein said internet advertising said data set including examples said records wherein but not limited to geography, conversion, click through, keywords, probabilities, cost;

The method wherein definitions; at least one data set; at least one datum; at least one record; at least one formed binary type software computational data file; executes; and at least one probability algorithm source code; wherein they refer to data other than tabular as well;

The method wherein said probability score saves wherein location said commercial internet advertising system workstation drive;

The method wherein said probability score saves said score location said commercial internet advertising system workstation drive wherein calculi data results decision tree. The method as in Claim 1 wherein units, such as but not limited to respectively, at least one speed connection, at least one processing, at least one failure wherein workflow rate is inherent;

The method wherein each said datum create new said probability scores wherein said computer internet advertising user profile displays thereon;

The method wherein additional iterations increase gathered statistical probability performance;

The method wherein multiple party users change probability across said computer user internet advertising profiles;

The method wherein additional iterations increase gathered statistical probability performance scores wherein higher competition results at different time intervals; The method wherein said advertising data set includes but is not limited to, simple opt in said impression accelerated internet advertisements;

The method wherein said probability score outputs wherein said internet advertisement computer user profile displays said score, including but not limited to acceptance, rejection, modified rate or continuous updates concerning advertisement;

The method wherein said internet advertising computer user selects, such as but not limited to, an opt in or opt out related datum wherein said internet advertising data set offers said user internet advertising computer user profile option test said impression accelerated internet advertisements;

The method wherein said probability score saves wherein location said commercial internet advertising system workstation computer system drive wherein updating said score;

The method screening tool wherein at least one advertising data set accesses said tools including high efficiency calculations including but is not limited to simple opt in said impression accelerated internet advertisements;

The method screening tool wherein multiple party users accelerate proficiency wherein said impression accelerated internet advertisements are inclusively chosen by opt in or continued automation said screening tool screening probabilities high rate efficiency; The method wherein at least one advisement emergency alert activates authority systems;

The method wherein at least one mobile device is implemented;

The method wherein at least one personal digital assistant, such as but not limited to, a cellular phone or authority radio, activates a remote internet advisement alert system via voice command;

The method wherein voice command includes fast voice activated or keypad menu options;

The method wherein at least one emergency alert wherein geographical area;

The method wherein at least one diverted binary code said at least one internet advertisement wherein location folder said database computer system at least one drive;

The method wherein at least one internet advertisement dump wherein location folder said database computer system at least one drive;

The method wherein computer processes modify performance adjusting said at least one developed Probability Density Algorithm at least one time;

The method wherein commercial computer use;

The method wherein commercial use using at least one graphical computer interface wherein said at least one said Probability Density Algorithm Graph at least at one given point in time is displayed on a computer;

The method wherein commercial use using at least one graphical computer interface wherein said at least one of the details said Actual Probability Density Algorithm Graph at one given point in time mapped or mapped transformation on an (X,Y) or (X,Y,Z) plane on a computer or television screen;

The method wherein commercial use using at least one graphical computer interface wherein said at least one of the details said Actual Probability Density Algorithm Graph at one given point in time mapped or mapped transformation on an (X,Y) or (X,Y,Z) plane on a computer or television screen wherein commercial computer user internet advertisement network interface profile provides actual data, further allowing computer users to make informative interactive decisions about probability internet advertisements, such as predicted effectiveness, cost, and the ability to interactively, through touch screen, voice, keyboard, or mouse adjust automatically the changes of individual and dependent datum to increase likelihood probability scores in an internet advertisement network profile or commercial computer workstation;

Method wherein continuously delivered said spectral dispersion point data said computer usage said datum said records consist constantly near mean average, sometimes near the mean average, within the normal distribution, or varies excessively away.

### BRIEF DESCRIPTION OF THE DRAWINGS

The present invention can best be understood in conjunction with the accompanying drawings, in which:

FIG. 1 is a flow diagram of internet computer advertising windows, computer work stations, and connectivity.

FIG. 2 is a flow diagram of a simplified connectivity computer work station connectivity and internet advertising database data set.

FIG. 3 is a flow diagram of internet computer advertising workstations accelerating advertisements.

FIG. 4 is a flow diagram of an emergency alert internet advertising system.

FIG. 5 is an emergency management mobile emergency alert internet advertising alert system.

FIG. 6 is a two-dimensional view of graphical probability and statistics and computer user interface display.

FIG. 7 is a flow diagram of data mining internet advertising database computer system method configuration.

### DETAILED DESCRIPTION OF THE INVENTION

It is well known that advertising on the internet is done through a computer system user interface. And that the computer user interface is accessed via typical drives, such as, hard disk, high-density, optical or laser activity that buffers to random access memory for operation through the motherboard. It is also well known that there are pluralities of workstations, internet connectivity, local-networking, mobile, and personal digital assistant devices utilizing such items as voice and touch screen technologies to connect all parties to create a working database system or allow methods to be utilized on the internet and intranets at corporations.

In this invention, the computer system advertising unified database system user interface is a system in part and whole located locally on hard-drives and servers and through internet protocol at times on storage systems, such as, IP telephony, mobile phones, mobile system storage devices and average home and laptop computers used for software installations, and the offer of the present invention is to use a method within these internet systems and to provide at least one form of a computer advertising system to take advantage of methods of data burst impressions as well as create a user-friendly interface shared with the same properties for others receiving at least one highly quantitative or qualitative score for user profile interfaces to change said score and situational advertisement and alert properties that include real world tests for created advertisements.

It is also well known to developers and software engineers in a business environment that Microsoft Excel has two macro programming languages available to create applications and run a system of calculations on the database in the spreadsheet in a written command by command line. One of those programs at present is the Microsoft Excel version 4.0 macro language. And the other is Visual Basic, a long time program available for many years and continuously updated. Visual Basic language is nominated as the best because it is more flexible and powerful than the Microsoft Excel version 4.0 macro language. However, macros, sometimes mini-applications, can be found on the internet for a plurality of purposes. For example, the lay user's purpose is to type in the command lines of the macro program language, a series of written lines to enable highlighting duplicate entries in a long list of addresses. The user can then see in, red, the rows of the spreadsheet that indicate a duplicate in a spreadsheet of thousands of possible entries that would otherwise be unrecognizable and difficult on the human eye to find. And this is how programming works to enable a user a benefit.

It can also be further said from the previous example, you may want to write additional line commands to delete these duplicate entries and put in better and more likely candidates for a mailing, based on age, demographic, or updated information as it becomes available. This would utilize a business network through an IT professional, an environment where information is available on another person's hard-drive, server, or mobile application storage device therein containing the program language for recognition for finding better possibilities. This would be recognized as database management for a business interested in communicating and calculating data between one another where the Excel spreadsheet would be the computer image interface.

Microsoft Visual Studio Professional 2008 is an available programming and database language, and working within these principles and others that follow, are applied information to allow for database engineers, to create said databases software and interface software aforementioned for internet advertising and multiple methods, herein explaining examples of mathematical technique, graphical discussion, programming information, and both basic and specific derivations are mentioned to allow a database engineer the necessary tools needed to create the same. And to further note, the attached drawings are defined to exhibit some of the graphical method mathematics and consumer uses to further supplement the examples. The database user image interfaces displaying on a computer screen for both online browsers and on the descriptive computer systems mentioned heretofore. For example, a database may be modified to stop internet advertisements on a command line basis, and use tools to create a system internet advertisement dump folder data collection, and internet advertisement diversion folder data collection with notification to user of an emergency of a temporarily diverted internet rejected advertisement, because an instance of imminent danger exists to at least one person. An alert authority specific database interface can be created on simple levels in at least one form of geographical area values set to take over said area network on internet advertising company computers and at least one internet ad per available network webpage, but not limited to using commands lines to create and interrupt an internet advertising company database operation for an emergency. The interface may also contain values recognizable to the internet advertising company database software, but not limited to, a variety of standard size internet advertisement alerts associated with current internet advertising formats, for immediate maximum exposure within the internet advertising company webpage delivery available specifications. The advertisements may also be “fit to” size of the space available or partially cover the space available. Command line interruption of advertisement software code either embedded in a website or delivered thereto, allows for law enforcement and emergency persons to channel useful software code that will operate open dialog chat boxes, vocal open radio and video formats, as well as touch screen capability and voice command remote operating system said database interface, through system integration techniques through the database building tool software. A universal design is disclosed by creating commands across many internet advertisement company website databases. The image interface software language, are typed as command lines or image placements as a part of the computer software program building tool, commonly known to the database engineer or software developer. Tools are available for working with images and tying created fields and data sets together. Data sets can also have windows within windows in user interface applications designed for the internet. A good use of data sets in the present invention would be the information input in fields at one point and including another set of windows having additional input fields. Input fields can have adjustments such as percentage increases or decreases that would also affect at least one value and an effect on a system based on at least one score, such as, but not limited to total probability score. The increasing and decreasing access to data burst tests is another example. This is accomplished through unique configuration of databases in the software database building tools. The at least one value affected may further allocate the increase of another value, for example but not limited to, the increase in price of the internet advertisement field for a test likelihood acceptance, having a low score, but estimated by user for a high success rate test, including but not limited to, including changing the rate of the total probability score upon the test success and recalculation in the database software method. While the total probability score field may decrease, in this instance, the user may have a better idea that it will work. And connective internet system open accesses the flow of information from the database internet advertising company location to the user interface data set evenly and as quickly as possible therein at least one update per session. The set of windows then belong to one data set and another data set is formed to create other input possibilities. This also allows mapping possibilities from one set to another, contextually tied together using the database software building tool. A plurality of data sets, windows, and fields can be created, using this method. So many data sets can exist with at least one window being at least one window whole user profile interface of said at least one dataset. And datasets can be connected by tools or program language uniformly to jump from data set to data set. This creates an opportunity to show the best data set highlighted in some form in a scoring system. The higher the score in one data set, having the highlight on at least that one data set in at least one color, such as but not limited to, on a created data set tab used to toggle between data sets, said highlighting providing the data set with variable data information flow from at least one data set dependent upon another data sets current inputs. This is all predicated on a standard set of tools to create an advertisement and open workflow to deliver to other websites from the internet advertising company's software and network. A visual profile interface is created on a desktop stand-alone software or through a browser or within an internet page, and can include additional visual objects thereon, such as, places for produced lists, menus, toolbars, and for use with various internet browsers. Where, further still, calls of action can take place in various menus having various test and outputs, including but not limited to, building economic standard rates per test or other measures. And various impression data bursts scenarios for advertisements and scoring can take place all in sets of data with output commands to activate central servers at the internet advertisers website, to take the action or actions as prescribed by inputs and commands with underlying command lines used to calculate the same through the database building tool for requests by the user. The program can be tested by the written command by command line that can offer the user to implement actions and calculations on a database, within the software, and more importantly the probability algorithms needed to iterate and output to user interfaces at the speed of the internet advertising pipeline or accessed database at least one iteration said at least one significant value, such as but not limited to, total probability against the calculated database possible economic standards for at least one opt in test of at least one data input in at least one data input field in at least one window. The database is well organized and incorporates probability algorithms for data tests and economic standard test monetary rates to the consumer. The best example of a probability algorithm and software that can be added to the database to modify and perform test through iterations and logical outputs, the screening data burst tool method, and the data burst method, is exemplary in the probability density function [PDF]. The standard general PDF and the surround attributes of various functions with the same algorithmic basis is the “integral from a to b of f(x) dx=Pr[a<=x<=b]. Further again, you might say an appropriate example and command line written test for right skewed data comes from a general example in the Weilbull [PDF]. Having the following example, it would also be informative to know and exemplary if explained as field inputs of at least one data set containing typical as well as scaled variable data from dispersion around the mean average normal distribution in a standard bell curve is added wherein the data is right skewed or poorer scoring advertising all based on the use of a public domain software called “Dataplot” wherein general distribution having (gamma=2) and x-axis is a positive number from zero to five and y is in increments 0.1 from zero to 0.9. An example of a plot of Weilbull Distrubution [PDF] command line in Dataplot Software is LET Y=WEIPDF(X,GAMMA,A,B). It is also useful to know testing capabilities for data bursts can be related to the skewed right, left or standard curve, applied a probability value on the y-axis. A simple example of this is to note the [PDF] with a new dispersion data point (i.e. customer parameter input field change) will skew the curve, either slightly, dramatically, or not at all. But when an advertisement data burst test is selected it is valued upon the current [PDF] that gives the user a selection that has a score. As the test selection may be increased or decreased for conversion ratios or click through ratios to name a few, the at least one dispersion data point value changes the score or at least one other input field. Further, using images, command line tools, through the database building software tool, the sophisticated, highly developed graphical interface, showing the user the database internet advertising profile, allows users to select dispersion points on the skewed or normal graph, automatically fitting at least one more data in at least one field and increasing the probability score as selected by a moving graphic horizontal line drawn to the y-axis. Converting probabilities and graphical functioning software within a database of variable and fixed data inputs in fields to a best scenario output from one to one-hundred is useful to consumer users. However, the confusion of PDF and database integration is lifted further with software system examples of Weilbull calculation in SAS JMP™, proprietary software that uses tables of data to create a Weilbull data plot much the same as data geographical physical location duplicate business addresses, explained earlier, are highlighted in data spreadsheets like Microsoft Excel Macro Language. This is significant to even the average database engineer to observe the necessary steps, as a spreadsheet, wherein you can add to databases, multiple variable and typical data, through observing a cohesive dispersion set, graphically, yet understand that spreadsheet tables and mathematical probability algorithms can serve as the most useful specific data values. When writing command lines and database building tools and interfaces, the necessary advantages to build data burst test tool screenings and data burst technology, is having at least one iteration of a plurality of internet advertisements yielding at least one score, wherein the fixed score through database tables or graphically yield test costs, such as but not limited to, the change of economic standard test cost differently associated to at least one conversion rate or at least one click through rate. The internet advertisement tools for advertisements are arranged for use in data sets and optimal performance appeal in standards set by marketing professionals, such as but not limited to uploads or interface actions upon text, images and video. An interruption and alert internet advertisement display to community or authority networks, including but not limited to, an internet advertisement diverted folder and a dump folder, possibly having an inherent economic value, as well as not limiting to a probability value in an advertising database consumer user profile.

The databases and database building tool, Microsoft Visual Professional 2008, are used merely as the example aids of the probability algorithm iteration database that is readily used for visual network on the internet on open access internet programs located on the computer desktop in software located on hard-drives on computers and laptops and other storage devices, such as, servers, IP telephony and mobile phones or on the internet or in the many replete examples of computers and connectivity mentioned thus far. This is only an example of the step procedure and such a program allowing the same.

### DETAILED DESCRIPTION OF THE DRAWINGS

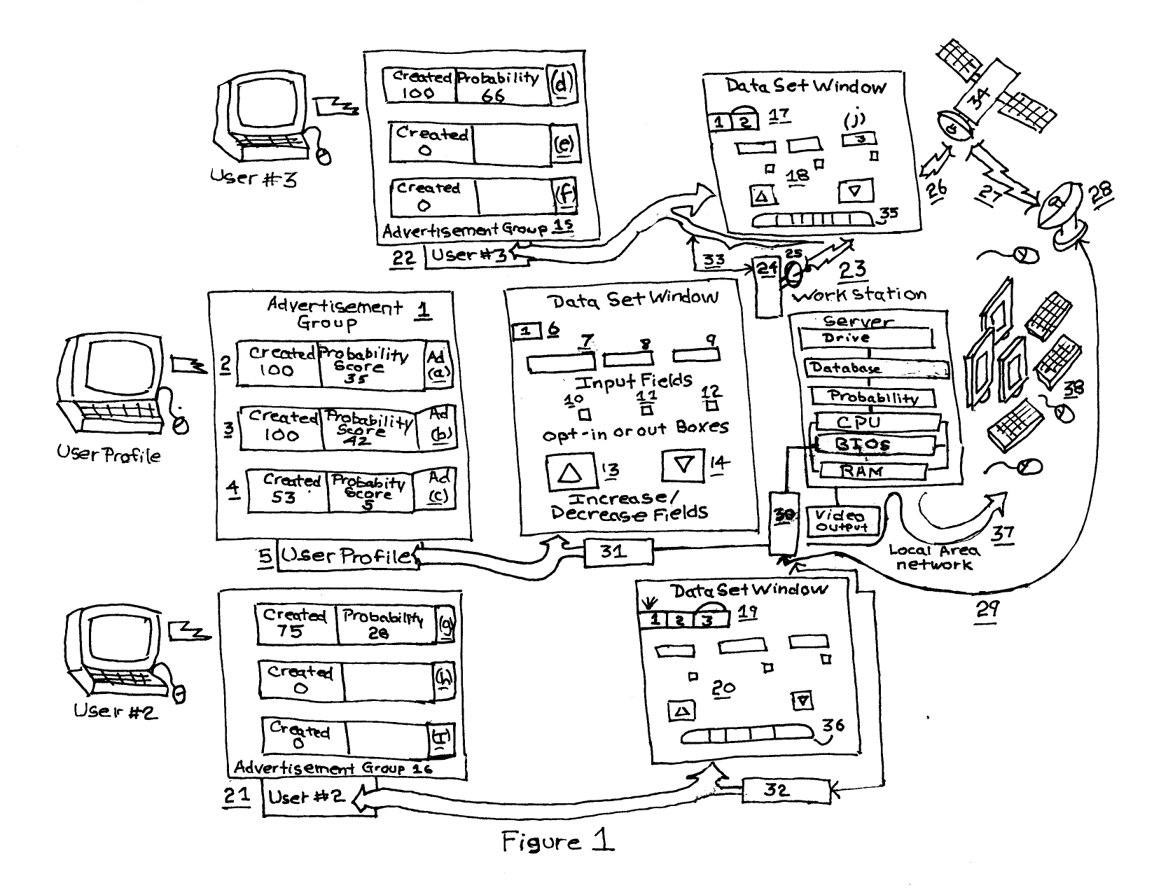

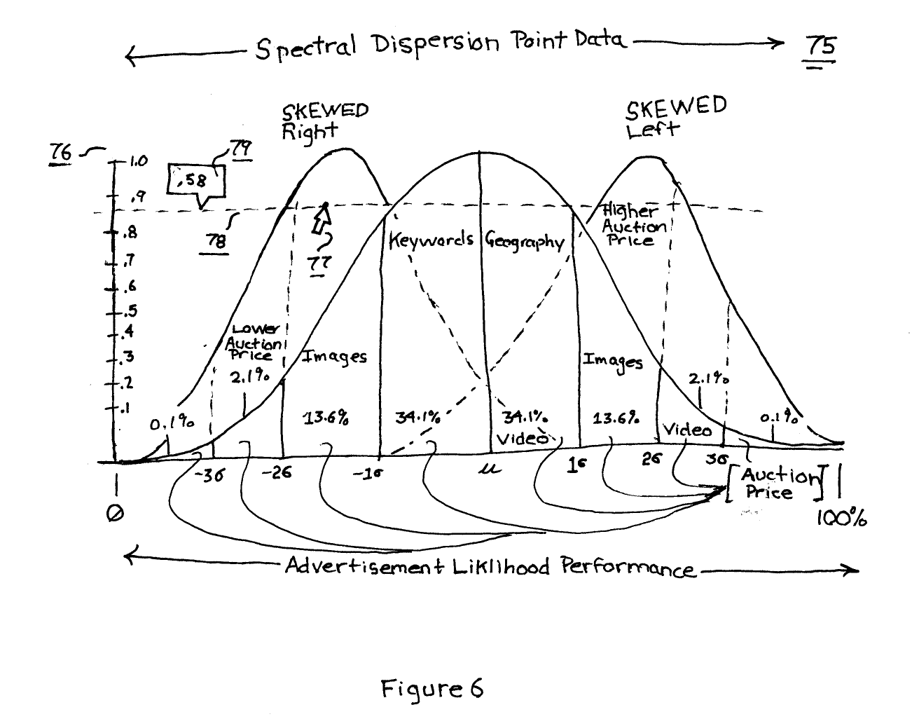

FIG. 1 shows a flow diagram that is merely an example of a powerful internet advertising interactive computation flowing advertisement software and is further related to computer type internet advertising database profile simplified screens 1, 5 and 22, having advertisement groups 1, 15, and 16, wherein advertisement created one-hundred percent (d) is exemplary allocated to data set window tabbed window two 17 and opened created datum data internet advertisements (e) and (f) having a value of zero or no probability are located in tab one next to indicated half circle tab two of data set window 17 where window data set 17 have datum input field opt in fields and field modulators increasing or decreasing said at least one field or multiple dependent fields 18. This is better shown in data set window one 6 where text fields 7, 8, and 9 collect related conversion rate datum upon internet advertising user input as well as keywords, cost, or geography datum. Fields 10, 11, and 12, are examples of opt in or opt out check boxes for internet advertising user input datum accelerated advertisement impressions or tests wherein increase and decrease field datum are sampled here as 13 and 14 further still carrying variables in single or dependent form through window 6 having window tab only one and three advertisements with created scores from same window one 6 of user profile 5 existing completion advertisements 2 at one hundred-percent 3 at one-hundred percent and 4 at fifty-three percent. The internet user advertisements 5 have respective probability scores (a) thirty-five percent (b) forty-two percent and (c) five percent. User two 21 has three separate advertisements (g), (h), and (i) in three separate tabs wherein data set window 19, having one respective advertisement therein each tabbed window one, two, and three. Available probability user internet advertiser can access probability score changes by at least one datum field 20. Internet advertisements can be excluded from probability simply by database engineer and an example of an initial datum input would be right field (j) of data set window 17 being value datum numeral three for expected conversions creating probability sixty-six of (d) in advertisement group 15. User profile 5 has a computer workstation for manipulating datum and passing it via cable connection network adapter 31 to internet advertising company workstation server 23 via network adapter 30 to a binary operating system having sufficient random access memory and computer processing unit thereby operating database and probability software on an ample drive and flowing the processed information back to user profile 5 as efficiently as possible. This is the same across multiple other user profiles 21 and 22 wherein 22 cable connect to outside of house 24, satellite dish 25 sending signal to satellite 26 and receiving and transmitting at least one data type binary file 27 to satellite receiver and transmitter 28, fiber optic cable 29 to network adapter 30 of internet advertising company workstation 23 of advertisement datum (j) and yielding probability (d) of sixty-six via workstation 23 transmission return flow said exact return path. Advertising datum from advertisement adjustment work on user profile paths process information via network adapter 32 to 30 and return yielding updated probability twenty-eight (g) of tab one data set window 19. The advertisement is tab is highlighted in 19 because it now has the highest probability in the ad group 21. Workstation 23 has video output to a local area network cable to at least one display wherein advertising company fixes bugs with mice and keyboards 38. User profile internet advertising users 21, 5, and 22, are now in flowing competition to set an advertisement in place at the right price. Objects 35 and 36 are created in window sets for accepting and sending advertisements, billing, notifications, another data screen outputs such as a spectral dispersion data graph for observing probabilities FIG. 6.

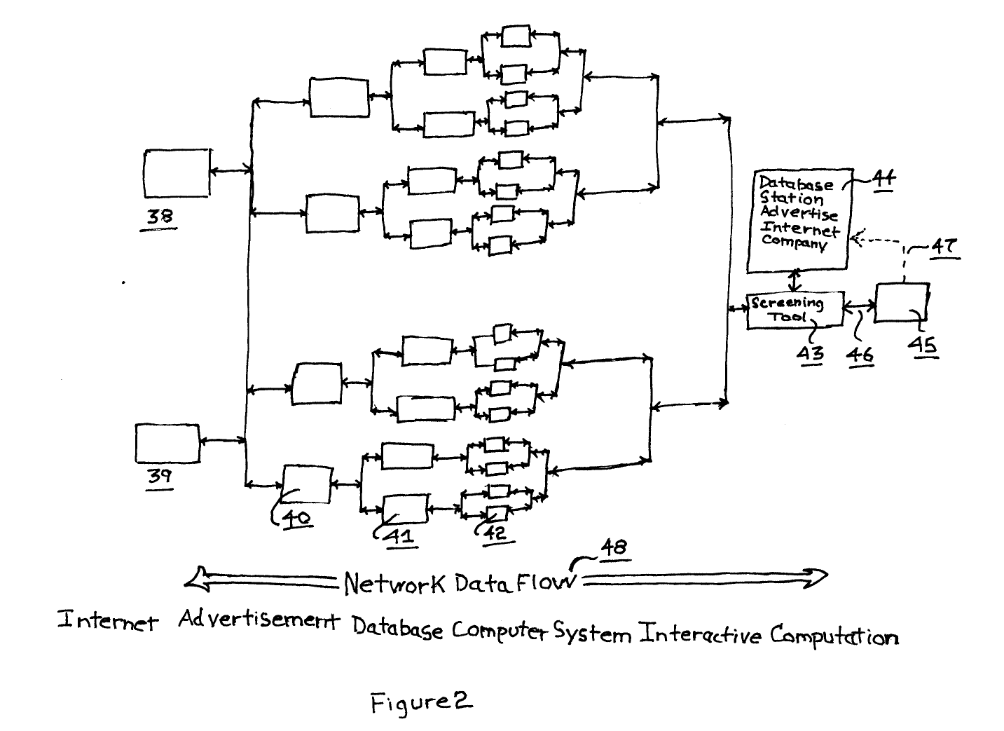

FIG. 2 Authority internet emergency advisement computer workstation 38 and internet advertising user computer workstation 39 interactively actively engage internet advertisement usage profiles said at least one datum input, wherein network data flow is shown through advertisement data sets 40 window data sets 41 and datum input sets 42 where screening tool 43 flows efficient data mining probability in Database computer workstation advertisement company 44 and transfers information either accelerated or common via network connection 46 to computer user webpage 45 wherein an action is taken transferred via 46 or 47 computing probability 43 and displays reactively on internet advertising user profiles 38 and 39.

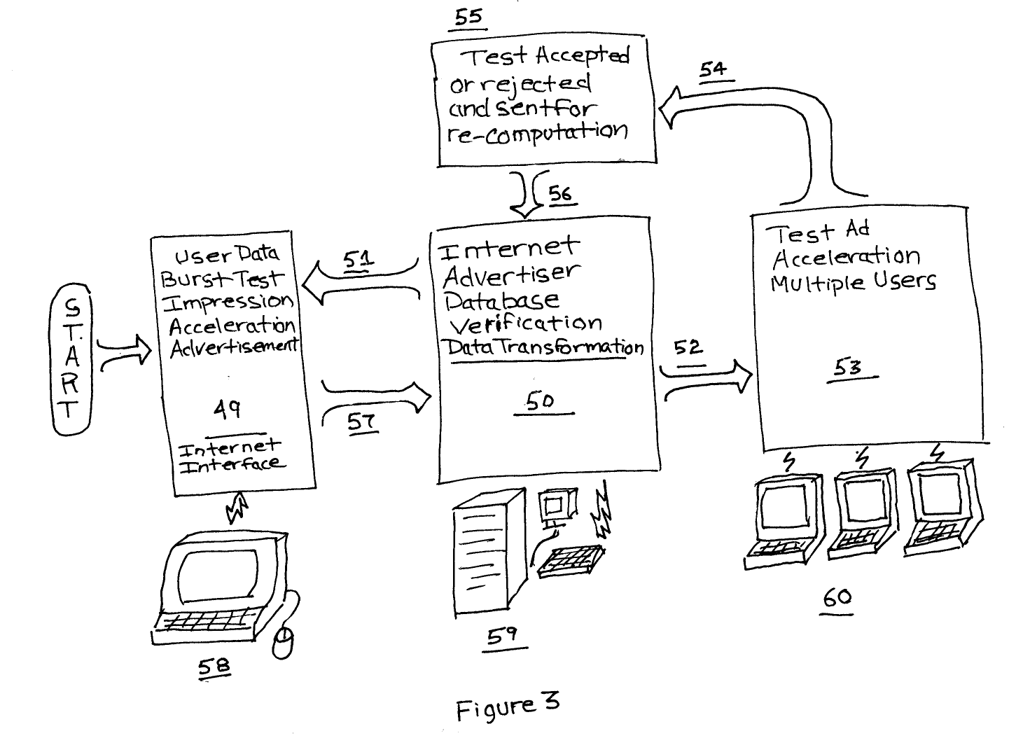

FIG. 3 Accelerated impression internet advertisement datum input 49 sent via 57 results probability via 51 user internet interface user accepted probability or opt in 49 via 57 to 50 transforming binary to 52 wherein 53 multiple users act 54 reactive set to actions 55 action calculi data 56 and 50 either mutually inclusive or mutually exclusive return some projection 51 to 49 and 50 modulates ad based on action score 52.

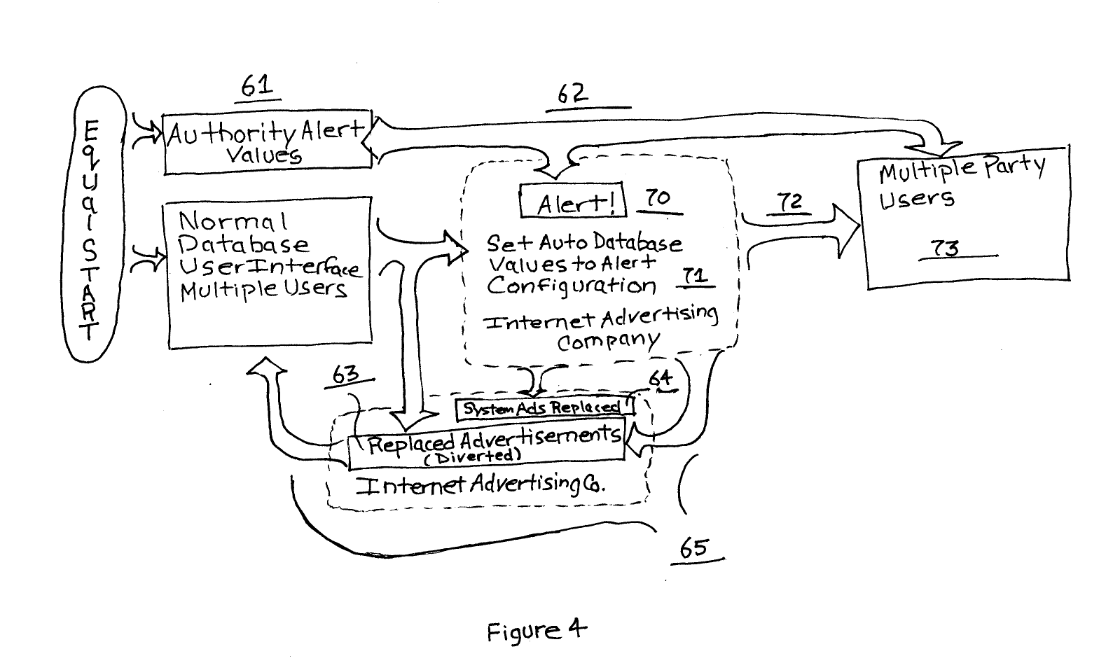

FIG. 4 Authority decides alert 61 via 62 to alert binary to re-order based on alert input datum 61 received 71 diverted folder ads users access same time to 63 notifies user of emergency 65 dumps system ads to folder 64 and rapidly alerts community 72.

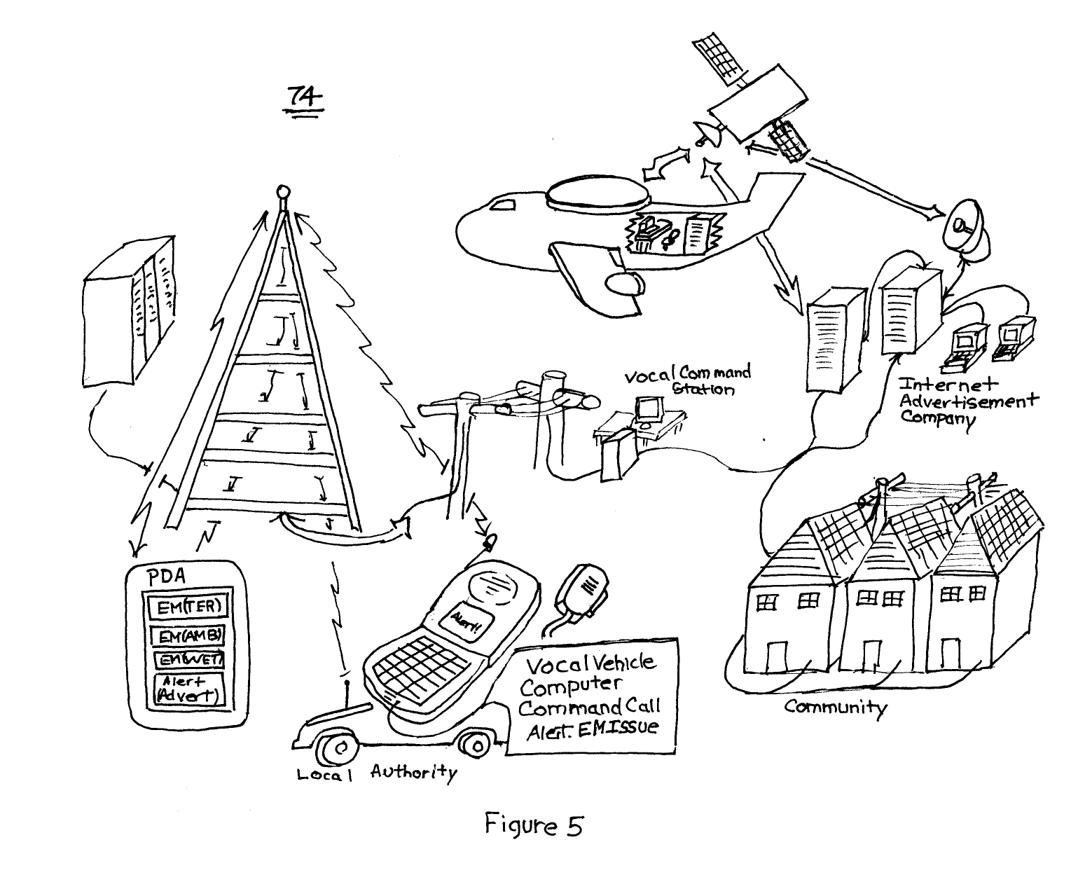

FIG. 5 Authority advisement alert mobile emergency scenario scene having all access available emergencies 74. Breakaway plane view shows computer system with satellite access 74.

FIG. 6 Statistical probability for example purposes 75 having skewed right Weilbull graphical interface skewed right with probability axis 76 in a computer screen or TV screen with mouse pointer 77 selecting a dispersion point and line 78 moving graphically while modifying price 79 and line are continuously displayed. Datum input dispersion example names showing deviations from the mean average u. Skewed left graph is provided around standard bell curve.

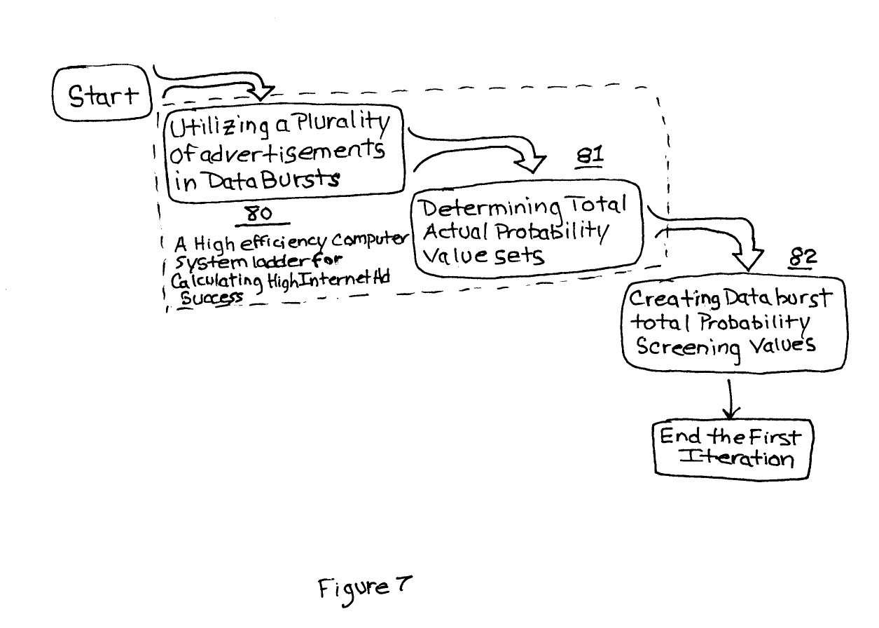

FIG. 7 Internet advertisement binary type files 80 having data mining logic 81 resulting screening values 82 for adding benefit to internet advertising.

I claim:

1. In a computer workflow environment having at least one commercial internet advertisement workstation computer via at least one network adapter thereto connectivity at least one internet advertising user workstation computer having at least one user using at least one internet advertising profile accessing at least one open transmission and reception communication via at least one network adapter a method for at least one internet advertising database computer system interactive computational flowing network software comprising:
(I) Said at least one internet advertising user accessing said internet advertising interactive computation database profile at least one data set creating at least one internet advertisement at least one datum assigned at least one record;
(II) Said datum said record at least one partially created advertisement;
(III) At least one formed binary type software computational data file created containing said record transfer said commercial advertising workstation;
(IV) Commercial internet advertising computer system workstation executes said database computer system interactive computation flowing database software created having at least one access at least one probability algorithm source code;
(V) Accessing at least one market system statistic control;
Wherein at least one computation creating at least one probability score said formed binary type software computational data file and output via network said internet advertising user profile said data set said probability score thereon.

2. In a computer workflow environment having at least one commercial internet advertisement workstation computer via at least one network adapter thereto connectivity at least one internet advertising user workstation computer having at least one user using at least one internet advertising profile accessing at least one open transmission and reception communication via at least one network adapter a method for at least one internet advertising database computer system comprising:
(I) Said user using at least one database object or at least one selection output using at least one window through at least one internet advertising data set said internet advertising user profile at least one impression acceleration advertisement at least one binary data set type file information transmits said commercial internet advertising workstation transmission;
(II) Said internet advertising database computer system receiving transforms said binary data type file information said impression acceleration advertisement via increasing hierarchy said internet advertising database computer system software configured internet advertisement scoring method therein at least one drive;
(III) Said internet advertising database computer system transmits at least one transformed said binary data set type file information said impression accelerated advertisement said transmitting at least one network advertiser;
(IV) At least one internet consumer computer system receives via at least one network adapter at least one webpage said transformed said impression acceleration advertisement said transformed said binary data set type file information embedded said advertisement impression;
(V) Said internet consumer computer user takes at least one resulting action;
(VI) Said resulting action said impression acceleration advertisement said transformed further said binary data set type file information transmitted fully or updating at least one parent binary set type file information data set located said internet advertising database computer system;
Wherein said internet advertising database computer system score system and adjusts said score.

3. In a computer workflow environment having at least one commercial internet advertisement workstation computer via at least one network adapter thereto connectivity at least one internet advertising user workstation computer having at least one user using at least one internet advertising profile accessing at least one open transmission and reception communication via at least one network adapter a method for at least one internet advertising database computer system:
(I) At least one internet impression acceleration advertisement at least one binary data type file information data set tested on score based actions;
(II) At least one database software having at least one incorporated probability algorithm software utilizing probability sampling or data mining, such as but not limited to, resulting transformation said binary data type file information set tested on score resulting score at least one variable association located said binary data type file information data set tested on score;
(III) Transforming said binary data type file information data set tested on score said variable having independent score;
Wherein screening tool is produced improving at least one additional iteration utilizing said variable wherein matching at least one score identifies previous score assisting new, such as but not limited to, at least one common internet advertisement or said internet impression accelerated advertisement data probability score increased efficiency.

4. In a computer workflow environment having at least one commercial internet advertisement workstation computer via at least one network adapter thereto connectivity at least one internet authority user workstation computer having at least one user using at least one internet alert advisement profile accessing at least one open transmission and reception communication via at least one network adapter an alert method said internet alert advisement database computer system:
(I) Said authority using at least one database object or at least one selection output using at least one window through at least one internet advisement data set said internet alert advisement authority profile at least one datum at least one record at least one internet alert advisement at least one binary data set type file information transmits said commercial internet advertising workstation transmission alert;
(II) Said commercial internet advertising workstation database computer system receiving transforms said binary data type file information at least one impression necessary said commercial internet advertising workstation said at least one internet advertisement database computer system software configured at least one internet advertisement scoring method at least one top hierarchy said impression said internet alert advisement therein at least one drive;
(III) Said commercial internet advertising workstation database computer system transmits at least one transformed said binary data set type file information said impression said internet alert advisement said transmitting at least one network advertiser;
(IV) At least one internet consumer computer system receives via at least one network adapter at least one webpage said transformed said impression said internet alert advertisement;
Wherein said consumer computer system user is informed via said internet alert advisement.

5. A method of creating at least one computer usage probability theory algorithm wherein spectral dispersion point data having finite set (S) wherein increased said computer usage said spectral dispersion point data records approach said (S) upper limit wherein theory said computer usage probability theory algorithm continuously calculates varied said (S) said spectral dispersion point data wherein at least one developed Probability Density Algorithm is created at least at one point in time.

6. The method as in claim 1 wherein efficient and successful configurations are located on computers, mobile phones, mobile workstations, including work stations that include at least one server, at least one remote authority radio or emergency operating advisement alert device, at least one personal digital assistant, having available at least one touch-screen, at least one voice command, at least one keyboard, each having at least one hard, high-density, optical, chip set, or laser drives with at least one computer processing unit(CPU) and sufficient at least one random access memory(RAM) including at least one binary operating system, at least one high speed satellite, cellular, Internet Protocol telephony, or land-line, such as cable, at least one network modem or transmitter/receiver adapter internet capability, at least one local network and at least one said at least one aforementioned at least one system located said commercial internet advertising company.

7. The method as in claim 1 wherein for at least one internet advertising database computer system interactive computational flowing network software wherein user and commercial computer components update on the fly.

8. The method as in claim 1 wherein said datum said record results said different than advertisement.

9. The method as in claim 1 wherein said advertising datum said internet user advertising profile said commercial advertising workstation database configuration wherein increasing and decreasing said datum, including but not limited to changing the dependency on other fields.

10. The method as in claim 1 wherein said internet advertising said data set said user profile uses opt in or opt out auto efficiency wherein objects, such as but not limited to option menus, toolbars, or lists offering selected tests, costs, probability and challenges.

11. The method as in claim 1 wherein said internet advertising said data set including examples said records wherein but not limited to geography, conversion, click through, keywords, probabilities, cost.

12. The method as in claim 1 wherein definitions; at least one data set; at least one datum; at least one record; at least one formed binary type software computational data file; executes; and at least one probability algorithm source code; wherein they refer to data other than tabular as well.

13. The method as in claim 1 wherein said probability score saves wherein location said commercial internet advertising system workstation drive.

14. The method as in claim 1 wherein said probability score saves said score location said commercial internet advertising system workstation drive wherein calculi data results decision tree.

15. The method as in claim 1 wherein units, such as but not limited to respectively, at least one speed connection, at least one processing, at least one failure wherein workflow rate is inherent.

16. The method as in claim 1 wherein each said datum create new said probability scores wherein said computer internet advertising user profile displays thereon.

17. The method as in claim 1 wherein additional iterations increase gathered statistical probability performance.

18. The method as in claim 1 wherein multiple party users change probability across said computer user internet advertising profiles.

19. The method as in claim 1 wherein additional iterations increase gathered statistical probability performance scores wherein higher competition results at different time intervals.

20. The method as in claim 2 wherein said advertising data set includes but is not limited to, simple opt in said impression accelerated internet advertisements.

21. The method as in claim 2 wherein said probability score outputs wherein said internet advertisement computer user profile displays said score, including but not limited to acceptance, rejection, modified rate or continuous updates concerning advertisement.

22. The method as in claim 2 wherein said internet advertising computer user selects, such as but not limited to, an opt in or opt out related datum wherein said internet advertising data set offers said user internet advertising computer user profile option test said impression accelerated internet advertisements.

23. The method as in claim 2 wherein said probability score saves wherein location said commercial internet advertising system workstation computer system drive wherein updating said score.

24. The method as in claim 3 screening tool wherein at least one advertising data set accesses said tools including high efficiency calculations including but is not limited to simple opt in said impression accelerated internet advertisements.

25. The method as in claim 3 screening tool wherein multiple party users accelerate proficiency wherein said impression accelerated internet advertisements are inclusively chosen by opt in or continued automation said screening tool screening probabilities high rate efficiency.

26. The method as in claim 4 wherein at least one advisement emergency alert activates authority systems.

27. The method as in claim 4 wherein at least one mobile device is implemented.

28. The method as in claim 4 wherein at least one personal digital assistant, such as but not limited to, a cellular phone or authority radio, activates a remote internet advisement alert system via voice command.

29. The method as in claim 4 wherein voice command includes fast voice activated or keypad menu options.

30. The method as in claim 4 wherein at least one emergency alert wherein geographical area.

31. The method as in claim 4 wherein at least one diverted binary code said at least one internet advertisement wherein location folder said database computer system at least one drive.

32. The method as in claim 4 wherein at least one internet advertisement dump wherein location folder said database computer system at least one drive.

33. The method as in claim 5 wherein computer processes modify performance adjusting said at least one developed Probability Density Algorithm at least one time.

34. The method as in claim 5 wherein commercial computer use.

35. The method as in claim 5 wherein commercial use using at least one graphical computer interface wherein said at least one said Probability Density Algorithm Graph at least at one given point in time is displayed on a computer.

36. The method as in claim 5 wherein commercial use using at least one graphical computer interface wherein said at least one of the details said Actual Probability Density Algorithm Graph at one given point in time mapped or mapped transformation on an (X,Y) or (X,Y,Z) plane on a computer or television screen.

37. The method as in claim 5 wherein commercial use using at least one graphical computer interface wherein said at least one of the details said Actual Probability Density Algorithm Graph at one given point in time mapped or mapped transformation on an (X,Y) or (X,Y,Z) plane on a computer or television screen wherein commercial computer user internet advertisement network interface profile provides actual data, further allowing computer users to make informative interactive decisions about probability internet advertisements, such as predicted effectiveness, cost, and the ability to interactively, through touch screen, voice, keyboard, or mouse adjust automatically the changes of individual and dependent datum to increase likelihood probability scores in an internet advertisement network profile or commercial computer workstation.

38. The method as in claim 5 wherein continuously delivered said spectral dispersion point data said computer usage said datum said records consist constantly near mean average, sometimes near the mean average, within the normal distribution, or vary excessively away.
